(19) United States
(12) Patent Application Publication
(10) Pub. No.: US 2007/0056922 A1
(43) Pub. Date: Mar. 15, 2007

(54) Multi-configuration crane

(76) Inventor: Michel Ciaburro, St-Bruno-de-Montarville (CA)

Correspondence Address: Louis Tessier, P.O. Box 54029, Town of Mount Royal, H3P 3H4, CA

(21) Appl. No.: 11/497,523

(22) Filed: Aug. 2, 2006

Related U.S. Application Data
(60) Provisional application No. 60/704,440, filed on Aug. 2, 2005.

(51) Int. Cl. B66C 23/26

(52) U.S. Cl. 212/175

(57) ABSTRACT

A kit for use in alternatively assembling a bridge crane and a jib crane, the kit being usable with a lifting equipment. The includes a support beam for supporting the lifting equipment; first and second substantially elongated laterally stabilizing-spacing members; first and second substantially elongated beam supporting-leg members; and a jib support member. The support beam is usable in both the bridge crane and in the jib crane to support the lifting equipment. In the bridge crane, the support beam is supported at two spaced apart support locations, the lifting equipment being mountable to the support beam between the two spaced apart support locations. In the jib crane, the support beam is supported in a cantilevered configuration, the lifting equipment being mountable to the support beam spaced apart from the jib support member.

This Application claims priority from U.S. Provisional Patent Application Ser. No. 60/704,440 filed Aug. 2, 2005.

### FIELD OF THE INVENTION

The present invention relates generally to lifting equipments. More specifically, the present invention is concerned with a multi-configuration crane.

### BACKGROUND OF THE INVENTION

Many types of cranes are commonly used. Two examples of such cranes are a jib crane and a bridge crane, the latter also being referred to as a gantry crane. Typically, each crane is better suited to perform specific tasks.

Accordingly, there is often a need for people who handle a variety of loads under a variety of conditions to own cranes of both types. However, owning many cranes is relatively expensive, as each crane has to be bought and maintained.

In addition, there is often a need to carry a crane from one location to another. However, prior art cranes are typically relatively cumbersome structures that are relatively difficult to carry between these locations.

Against this background, there exists a need in the industry to provide a novel multi-configuration crane. An object of the present invention is therefore to provide an improved multi-configuration crane.

### SUMMARY OF THE INVENTION

In a first broad aspect, the invention provides a kit for use in alternatively assembling a bridge crane and a jib crane, said kit being usable with a lifting equipment. Said kit comprises:

a support beam for supporting the lifting equipment;

first and second substantially elongated laterally stabilizing-spacing members;

first and second substantially elongated beam supporting-leg members, said first beam supporting-leg member defining substantially longitudinally opposed first beam supporting-leg member first and second ends, said second beam supporting-leg member defining substantially longitudinally opposed second beam supporting-leg member first and second ends;

a jib support member;

wherein in said bridge crane
said first and second laterally stabilizing-spacing members are located in a substantially coplanar and spaced apart relationship relatively to each other, said first and second laterally stabilizing-spacing members defining a bridge crane reference plane in which said first and second laterally stabilizing-spacing members both extend;
said first and second beam supporting-leg members are respectively attached to said first and second laterally stabilizing-spacing members so as to extend substantially away from said reference plane; and
said support beam is attached to both said first and second beam supporting-leg members at a location respectively spaced apart from said first and second beam supporting-leg members first ends;

in said jib crane
said first and second beam supporting-leg members are located in a substantially coplanar and spaced apart relationship relatively to each other, said first and second laterally stabilizing-spacing members defining a jib crane reference plane in which said first and second laterally stabilizing-spacing members both extend;
said first and second laterally stabilizing-spacing members are each attached to both said first and second beam supporting-leg members;
said jib support member is attached to at least one of said first and second laterally stabilizing-spacing members and extends substantially away from said jib reference plane; and
said support beam is attached to said jib support member so as to be substantially spaced apart from said first and second beam supporting-leg members;

said support beam being used in both said bridge crane and in said jib crane to support the lifting equipment, wherein
in said bridge crane, said support beam is supported at two spaced apart support locations, the lifting equipment being mountable to said support beam between said two spaced apart support locations; and
in said jib crane, said support beam is supported in a cantilevered configuration, the lifting equipment being mountable to said support beam spaced apart from said jib support member.

Advantageously, the kit allows to assemble components synergistically so as to the use of the same components to assemble the jib crane and the bridge crane. Therefore, this reduces the need for an intended user to own both a bridge crane and a jib crane, which reduces ownership costs.

In addition, the cranes assembled using the kit are relatively easy to assemble and disassemble. When disassembled, the kit forms a relatively compact package that is relatively easy to transport.

Furthermore, the kit is relatively ergonomic to use and relatively inexpensive to manufacture.

In some embodiments of the invention, the support beam is of a substantially “I”-shaped cross-section and supports a trolley to which a lifting equipment, such as, for example, a hoist, is attached. The trolley rolls onto the “I”-beam so as to allow a substantially longitudinal translation of the lifting equipment relative to the support beam.

In another broad aspect, the invention provides a kit for use in alternatively assembling a bridge crane and a jib crane, said kit being usable with a lifting equipment, said kit comprising:

a support beam for supporting the lifting equipment;

first and second substantially elongated laterally stabilizing-spacing members;

first and second substantially elongated beam supporting-leg members, said first beam supporting-leg member defining substantially longitudinally opposed first beam supporting-leg member first and second ends, said second beam supporting-leg member defining substantially longitudinally opposed second beam supporting-leg member first and second ends;

a jib support member;

wherein in said bridge crane
said first and second laterally stabilizing-spacing members are located in a substantially coplanar and spaced apart relationship relatively to each other, said first and second laterally stabilizing-spacing members defining a bridge crane reference plane in which said first and second laterally stabilizing-spacing members both extend;
one of said first and second beam supporting-leg members is attached to one of said first and second laterally stabilizing-spacing members so as to extend substantially away from said reference plane
another one of said first and second beam supporting-leg members is attached to either another one of said first and second laterally stabilizing-spacing members or to said jib support member so as to extend substantially away from said reference plane; and
said support beam is attached to both said first and second beam supporting-leg members at a location respectively spaced apart from said first and second beam supporting-leg members first ends;

in said jib crane
said first and second beam supporting-leg members are located in a substantially coplanar and spaced apart relationship relatively to each other, said first and second laterally stabilizing-spacing members defining a jib crane reference plane in which said first and second laterally stabilizing-spacing members both extend;
said first and second laterally stabilizing-spacing members are each attached to both said first and second beam supporting-leg members;
said jib support member is attached to at least one of said first and second laterally stabilizing-spacing members and extends substantially away from said jib reference plane; and
said support beam is attached to said jib support member so as to be substantially spaced apart from said first and second beam supporting-leg members;

said support beam being used in both said bridge crane and in said jib crane to support the lifting equipment, wherein
in said bridge crane, said support beam is supported at two spaced apart support locations, the lifting equipment being mountable to said support beam between said two spaced apart support locations; and
in said jib crane, said support beam is supported in a cantilevered configuration, the lifting equipment being mountable to said support beam spaced apart from said jib support member.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1, in a perspective view, illustrates a bridge crane assembled from a kit in accordance with an embodiment of the present invention;

FIG. 2, in a perspective view, illustrates a jib crane assembled from the kit used to assemble the crane of FIG. 1;

FIG. 3, in a perspective view, illustrates another jib crane assembled from the kit used to assemble the crane of FIG. 1;

FIG. 4, in a perspective view, illustrates a trolley usable with the cranes of FIGS. 1, 2 and 3;

FIG. 5, in a perspective view, illustrates the trolley of FIG. 4 mounted to s support beam used in the assembly of the cranes of FIGS. 2, 3 and 4;

FIG. 6, in a in a front elevation view, illustrates an alternative support beam usable in the assembly of the cranes of FIGS. 2, 3 and 4; and

FIG. 7, in a perspective exploded view, illustrates the crane of FIG. 2.

### DETAILED DESCRIPTION

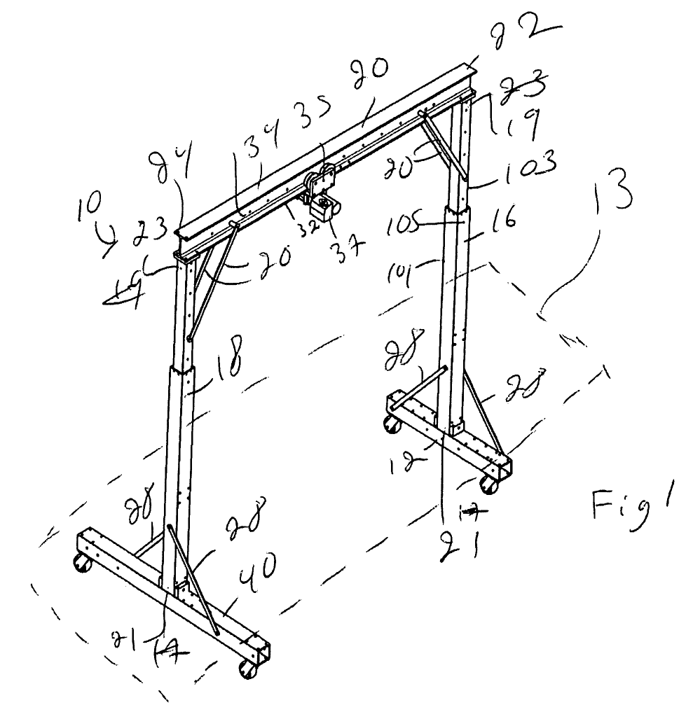

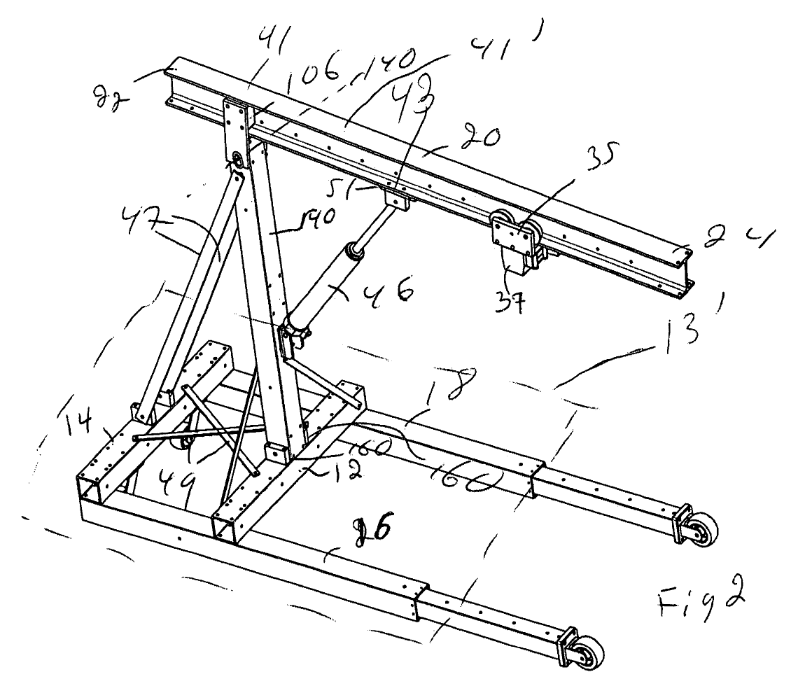

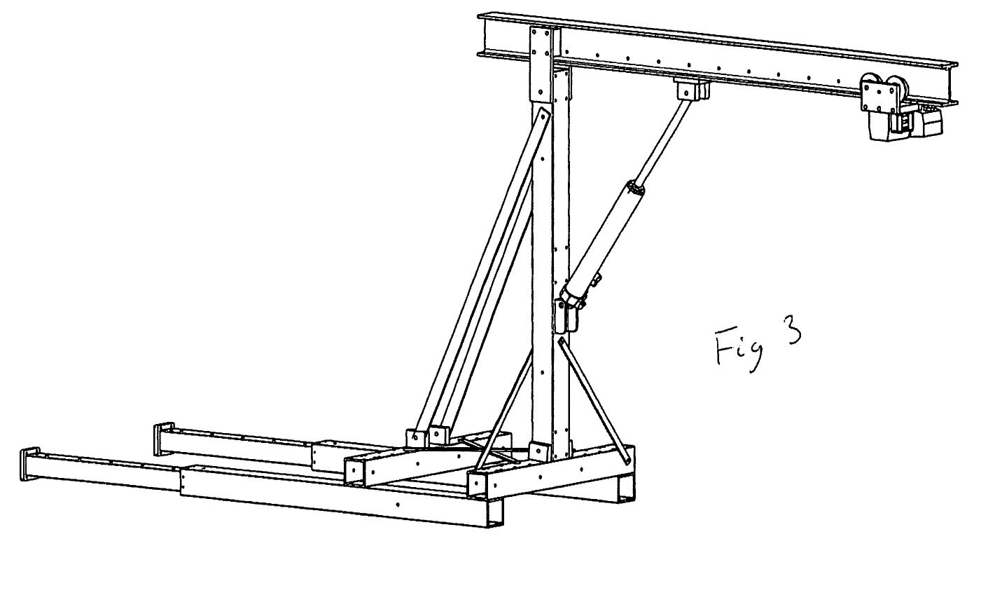

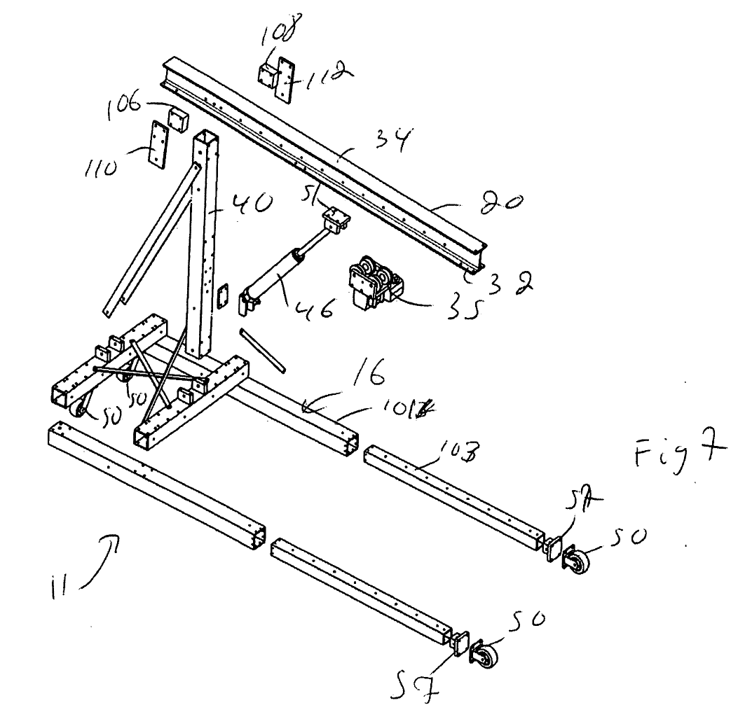

FIG. 1 illustrates a bridge crane 10 assembled from a kit 11 (better seen in FIG. 7). FIGS. 2 and 3 illustrates jib cranes 10′ and 10″ that are assembled from the same kit 11. The different components making up the kit 11 are better seen in the exploded view seen in FIG. 7. The kit 11 includes first and second laterally stabilizing-spacing members 12 and 14. The kit further includes first and second beam supporting-leg members 16 and 18, a support beam 20 and a jib support member 40.

In the bridge crane 10, the first and second laterally stabilizing-spacing members 12 and 14 are located in a substantially coplanar and spaced apart relationship relatively to each other, the first and second laterally stabilizing-spacing members 12 and 14 defining a bridge crane reference plane 13 in which the first and second laterally stabilizing-spacing members 12 and 14 both extend.

In some embodiments of the invention, the first and second beam supporting-leg members 16 and 18 are respectively attached to the first laterally stabilizing-spacing members 12 and to the jib support member 40 so as to extend substantially away from the bridge crane reference plane 13. In alternative embodiments of the invention, the first and second beam supporting-leg members 16 and 18 are respectively attached to the first and second laterally stabilizing-spacing members 12 and 14 so as to extend substantially away from the reference plane 13. In embodiments wherein the jib support member 40 is longer than the second laterally stabilizing-spacing members 14, using the jib support member 40 to support the second beam supporting-leg members 18 brings stability to the bridge crane 10 in a transverse direction extending perpendicularly to the support beam 20. In the same embodiments, using the second laterally stabilizing-spacing members 14 to support the second beam supporting-leg members 18 makes the bridge crane 10 more compact.

The support beam 20 is attached to both the first and second beam supporting-leg members 16 and 18 at a location respectively spaced apart from the first and second beam supporting-leg members ends that are substantially adjacent to the bridge crane reference plane 13.

In the jib cranes 10′, 10″, the first and second beam supporting-leg members 16 and 18 are located in a substantially coplanar and spaced apart relationship relatively to each other. The first and second laterally stabilizing-spacing members 16 and 18 define a jib crane reference plane 13′ in which the first and second laterally stabilizing-spacing members 16 and 18 both extend.

The first and second laterally stabilizing-spacing members 16 and 18 are each attached to both the first and second beam supporting-leg members 12 and 14. Also, the jib support member 40 is attached to at least one of the first and second laterally stabilizing-spacing members 12 and 14, for example to the second laterally stabilizing-spacing members 14, and extends substantially away from the jib reference plane 13′. The support beam 20 is attached to the jib support member 40 so as to be substantially spaced apart from the first and second beam supporting-leg members 16 and 18.

The support beam is used in both the bridge crane 10 and in the jib cranes 10′, 10″ to support the lifting equipment, for example and non-limitingly, a trolley 35 to which a winch 37 is attached. In the bridge crane 10, the support beam 20 is supported at two spaced apart support locations, the lifting equipment being mountable to the support beam 20 between the two spaced apart support locations. In the jib crane, the support beam 20 is supported in a cantilevered configuration, the lifting equipment being mountable to the support beam 20 spaced apart from the jib support member 40.

For example, and non-limitingly, the first and second laterally stabilizing/spacing members 12 and 14, the first and second beam supporting/leg members 16 and 18 and the jib support member 40 are substantially elongated and each take the form of a tube having a substantially square cross-section. The square cross-section allows to transmit loads between tubular members that abut each other while creating only relatively small pressures between these members. Also, tubes are easily packaged relatively compactly for transportation of the disassembled kit 11. In alternative embodiments of the invention, only some or none of the first and second laterally stabilizing/spacing members 12 and 14, the first and second beam supporting/leg members 16 and 18 and the jib support member 40 take the form of a tube having a substantially square cross-section.

A difference existing between the two jib cranes 10′ and 10″ is made possible by the fact the support beam 20 is alternatively attachable to the jib support member 40 in an internally extending configuration, in the jib crane 10′, and in an externally extending configuration, in the jib crane 10″. In the internally extending configuration, the support beam 20 and the first and second beam supporting-leg members 16 and 18 extend substantially in the same direction. This bring stability to the jib crane 10′. In the externally extending configuration, the support beam 20 extends in a direction opposite to a direction in which the first and second beam supporting-leg members 16 and 18 extend, which allows to lift loads that are outside of a support footprint created by the first and second beam supporting-leg members 16 and 18. In these latter embodiments, it is possible to put weights onto the first and second beam supporting-leg members 16 and 18 to prevent the crane 10″ from capsizing.

Another structural difference between the jib cranes 10′ and 10″ resides in the attachment location of the jib support member 20. Indeed, the jib support member 40 is alternatively attachable to each of the first and second laterally stabilizing-spacing members 12 and 14. This allows to alternatively attach the jib support member 40 to the one of the first and second laterally stabilizing-spacing members 12 and 14 that is either closest (in the jib crane 10″) or further away (in the jib crane 10′) from an extremity of the first and second beam supporting-leg members 16 and 18 so as to have a relatively sturdy and stable crane.

The first beam supporting/leg member 16 is substantially elongated and defines first beam supporting/leg member first and second ends 17 and 19. The second beam supporting/leg member 18 is substantially elongated and defines second beam supporting/leg member first and second ends 21 and 23. In the specific embodiment of the invention shown in the drawings, in the bridge crane 10, the first and second beam supporting/leg members 16 and 18 are substantially elongated and positioned substantially vertically.

The first laterally stabilizing/spacing members 12 and the jib support member 40 are each secured to a respective one of the first and second beam supporting/leg members 16 and 18 substantially adjacent respectively the first and second beam supporting/leg member first ends 17 and 21. The first laterally stabilizing/spacing members 12 and the jib support member 40 stabilize the crane 10.

The support beam 20 is substantially elongated and defines beam first and second ends 22 and 24. The support beam 20 is secured to the first and second beam supporting/leg members 16 and 18 so that the beam first end 22 is positioned substantially adjacent the first beam supporting/leg member second end 19 and the beam second end 24 is positioned substantially adjacent the second beam supporting/leg member second end. However, in alternative embodiments of the invention, the support beam 20 and the first and second beam supporting/leg member 16 and 18 are positioned relative to each other in any other suitable manner.

In some embodiments of the invention, the first and second beam supporting/leg members 16 and 18 are telescopic. This allows for the adjustment of the height of the beam 20 relatively to the ground. Adjustment of the height is performed in any suitable manner, for example, through the use of nuts and bolts that are inserted into telescopic members at suitable locations, as it is well known in the art. More generally, at least one of the first and second beam supporting-leg members 16 and 18 is selectively configurable between a leg shortest configuration and leg longest configuration, wherein in the leg shortest configuration, the length of the at least one of the first and second beam supporting-leg members 16 and 18 is smaller than the length of the at least one of the first and second beam supporting-leg members 16 and 18 in the leg longest configuration.

This is achieved for example by having the at least one of the first and second beam supporting-leg members 16 and 18 which includes a first leg tube 101 and a second leg tube 103 slidably mounted within the first leg tube 101. Alternating between the leg shortest and longest configurations is achieved, at least in part, by sliding the second leg tube 103 relatively to the first leg tube 101. A lock 105 is provided for locking the first and second leg tubes 101 and 103 relatively to each other so as to prevent the first and second leg tubes 101 and 103 from sliding relatively to each other. For example, the lock 105 includes a fastener insertable into two holes extending inwardly into the first and second leg tubes 101 and 103 when the two holes are substantially in register with each other.

The first laterally stabilizing/spacing member 12 and the jib support member 40 are supported by the ground substantially perpendicularly to the support beam 20. In the embodiment of the invention shown in the drawings, the first and second beam supporting/leg members 16 and 18 are supported respectively onto the first laterally stabilizing/spacing members 12 and the jib support member 40. However, it is within the scope of the invention to have a first laterally stabilizing/spacing member 12 and a jib support member 40 that are secured to the first and second beam supporting/leg members 16 and 18 in any other suitable manner.

As shown in FIG. 1, in some embodiments of the invention, reinforcing members 28 extend between the first and second beam supporting/leg members 16 and 18 and the first and second laterally stabilizing/spacing members 12 and 14. The reinforcing members 28 are angled with respect to both the first and second beam supporting/leg members 16 and 18 and the first and second laterally stabilizing/spacing members 12 and 14. Similar reinforcing members 26 interconnect the support beam 20 and the first and second beam supporting/leg members 16 and 18. More generally, the reinforcing members 26, 28 are attachable to at least two distinct members from the set consisting of the first and second beam supporting-leg members 16 and 18, the first and second laterally stabilizing-spacing members 12 and 14 and the jib support member 40 so as to triangulate the at least two distinct members.

For example, the reinforcing members 26 and 28 are substantially elongated and substantially planar. In some embodiments of the invention, at least some of the reinforcing members 26 and 28 are positioned, configured and sized to operate in tension under an application of a load onto the bridge crane 10.

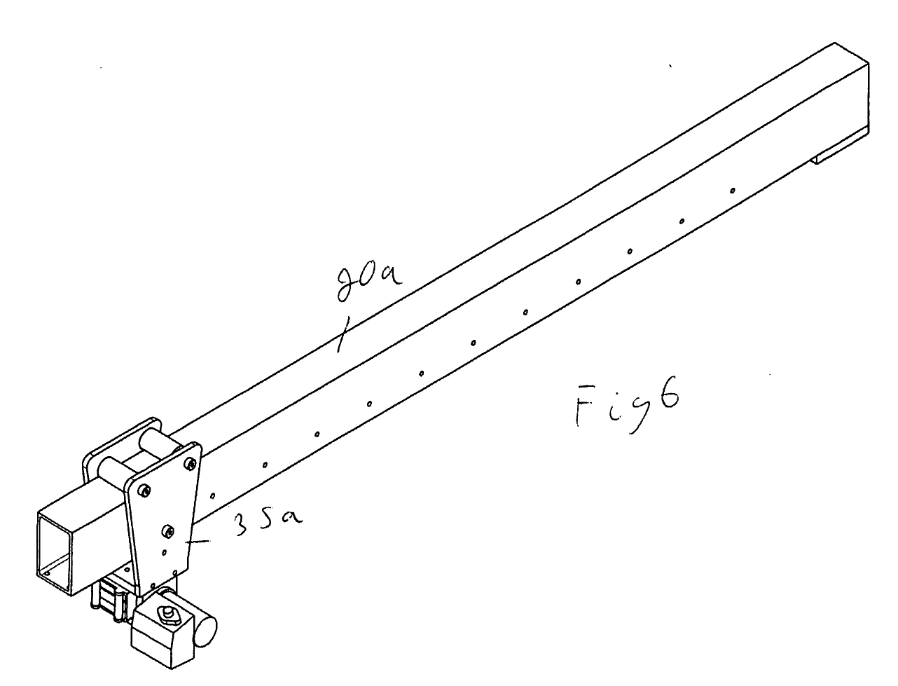

The support beam 20 is of substantially “I”-shaped cross-section. The beam 20 includes first and second outer plates 32 and 34, the first and second outer plates 32 and 34 being in a substantially parallel and spaced apart relationship relatively to each other. An intermediate plate 36 extends from both the first and second outer plates 32 and 34 so as to connect the first and second outer plates 32 and 34 to each other. However, it is within the scope of the invention to have support beams 20 of any other suitable shape. For example, FIG. 6 shows an alternative support beam 20a having a substantially tubular configuration with a substantially square cross-section receiving an alternative trolley 35a.

In the embodiment of the invention shown in FIGS. 2 and 3, and as better seen in FIG. 7, two beam blocks 106 and 108 are attached to the support beam 20 between the first and second outer plates 32 and 34. Two block-to-jib support linking members 110, for example in the form of plates, are each attached to a respective one of the beam blocks 106 and 108 and to the jib support member 40, thereby attaching the support beam 20 to the jib support member 40.

In these embodiments, the support beam 20 is pivotally attached to the jib support member 40 so as to be pivotable about a pivot axis 140, the pivot axis 140 being substantially parallel to the jib crane reference plane. The kit 11 then includes, in some embodiments of the invention, a beam pivoting component, the beam pivoting component being operatively coupled to the support beam 20 for selectively pivoting the support beam 20 about the pivot axis 140 so as to move an extremity of the beam 20, for example the beam second end 24, substantially away from the jib crane reference plane 13′.

In some embodiments of the invention, the beam pivoting component is substantially elongated, the beam pivoting component being attached to both the support beam 20 and the jib support member 40 at locations substantially distal relatively to locations at which the support beam 20 and the jib support member 40 are attached to each other. The beam pivoting component is selectively operable between a shortest lifting component configuration and a longest lifting component configuration, wherein in the shortest lifting component configuration the beam pivoting component is shorter than in the longest pivoting component configuration. Changing a length of the beam pivoting component pivots the beam pivoting component relatively to the jib support member 40.

Therefore, the support beam 20 is secured to the jib configuration support member 40 at a first beam support location 41 and at a second beam support location 43. The first beam support location 41 is substantially adjacent the beam first end 22. The second beam support location 43 is intermediate the beam first and second ends 22 and 24.

An example of a suitable beam lifting component is a hydraulic jack 46. The hydraulic jack 46 extends between the jib support member 40 and the beam 20. The hydraulic jack 46 is secured to the support beam 20 at the second beam support location 43. For example, a detachable attachment plate 51 attachable to both the support beam 20 and to the hydraulic jack 46 is provided for interconnecting the hydraulic jack 46 and the support beam 20. Also, the hydraulic jack 46 is attached to the jib support member 40 at a location intermediate the extremities of the jib support member 40.

However, in other embodiments of the invention, the hydraulic jack 46 is not provided and is replaced with a substantially rigid member. In yet other embodiments of the invention, the support beam 20 is secured to the jib configuration support member 40 in any other suitable manner.

In the jib crane 10′, 10″, the jib support member 40 is supported by one of the first laterally stabilizing/spacing members 12 and 14 and extends substantially vertically. Reinforcing members 47 interconnect the jib configuration support member 40 and the other one of the first and second laterally stabilizing/spacing member 12 and 14 such as to reinforce the jib crane 10′, 10″ to allow the jib support member 40 to support relatively large loads without damaging the jib crane 10′, 10″. Also, the first and second laterally stabilizing/spacing members 12 and 14 are also interconnected by reinforcing members 49.

Many variants of the kit are within the scope of the invention. For example, in some embodiments of the invention:

the trolley 35 is replaced by an alternative trolley that is slidable relative to the support beam 20;

another lifting equipment, such as for example a hoist 48, is supported by the trolley 35;

wheels 50 are secured to the bridge and jib cranes 10, 10′, 10″ for supporting the bridge and jib cranes 10, 10′, 10″ onto the ground and allow an intended user to roll the bridge and jib cranes 10, 10′, 10″ onto the ground. For example, the wheels 50 may be attachable to a wheel mounting component 57 that is at least partially insertable into the second tube 103. In the same embodiments, the wheel mounting components 57 are also usable to attach the support beam 20 thereto in the bridge crane 10.

In some embodiments of the invention, the support beam 20 is substantially elongated and defines two substantially longitudinally spaced attachment locations 41 and 41′. The support beam 20 is attachable to the jib support member 40 alternatively at both of the attachment locations 41 and 41′. However, in alternative embodiments of the invention, the support beam 20 includes less or more than 2 attachment locations.

In some embodiments of the invention, in the jib crane 10′, 10″, the member from the first and second laterally stabilizing-spacing members 12 and 14 to which the jib support member 40 is attached includes a pair of substantially outwardly extending flanges 160, the substantially outwardly extending flanges 160 being substantially spaced apart from each other. The jib support member 40 is positioned between and attached to both of the substantially outwardly extending flanges 160. For example, and non-limitingly, the flanges 160 include substantially plate-shaped members that are removable attachable to the first and second laterally stabilizing-spacing members 12 and 14. Also, other components of the kit 11 may be similarly attached to each other.

The reader skilled in the art will readily appreciate that when in the bridge configuration, the bridge crane 10 does not necessarily include the hydraulic jack 46 and the jib configuration support member 40. Therefore, these parts are provided mainly for use in the jib configuration.

The above-described components of the bridge crane 10 are secured to each other in any suitable manner, for example using nuts and bolts. The reader skilled in the art will readily appreciate that these components may also be secured using any other known securing method known in the art. However, the use of nuts and bolts is advantageous in cases wherein it is desired that the crane 10 be relatively easy to disassemble while keeping a relatively good structural integrity when assembled.

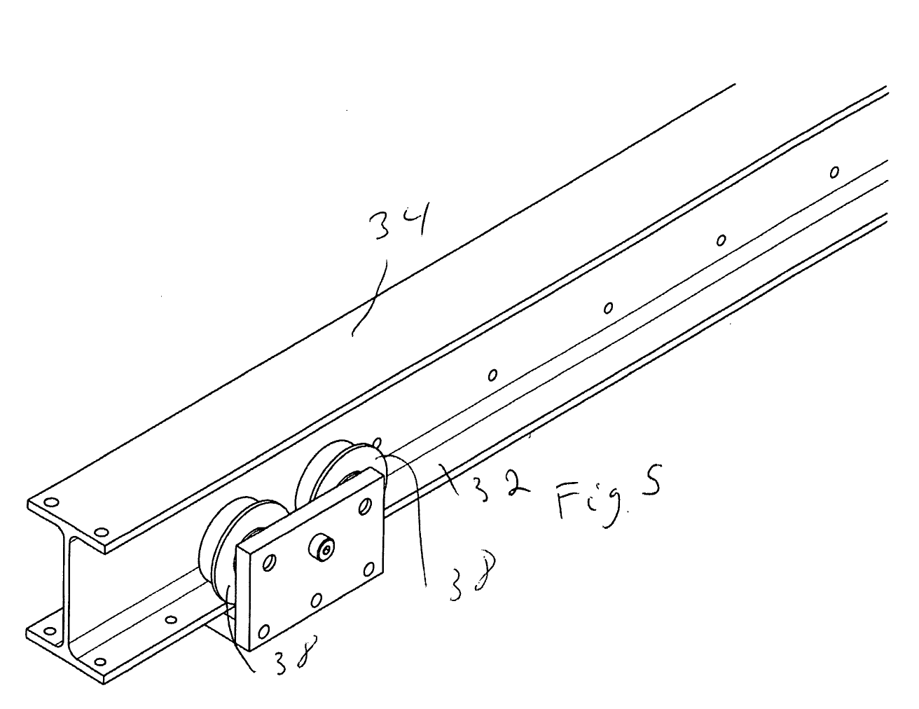

Referring to FIG. 5, the trolley 35 is substantially longitudinally movable relatively to the support beam 20 and is supported by the outer plate 32. In some embodiments of the invention, the trolley 35 includes wheels 38 that operatively engage the lower one of the outer plates 32 for allowing the wheels 38 to roll thereonto. For example, the wheels have radially outwardly and laterally outwardly extending flanges to stabilize the trolley 35 onto the support beam 20.

In some embodiments of the invention, for example as seen in FIG. 6, a trolley 37 includes one or more trolley aperture 155 and support beam 20′ includes beam apertures 159. The trolley and beam plate apertures 155 and 159 are provided to receive a bolt 157 therethrough when they are substantially in register. When the bolt 157 is received by the trolley and beam apertures 155 and 159, the trolley 35′ is substantially immobilized with respect to the support beam 20′.

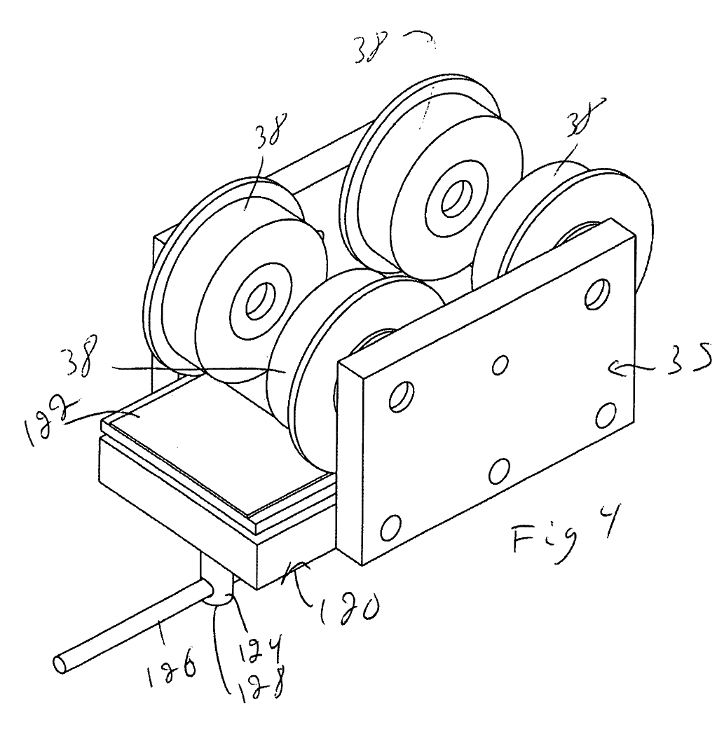

In other embodiments of the invention, as better seen in FIG. 4, the trolley 35 includes a brake 120 for selectively blocking and allowing a substantially longitudinal movement of the trolley 35 relatively to the support beam 20. For example, the brake 120 includes a pad 122 that is movable so as to selectively engage the support beam 20. For example, in an engaged configuration, the pad 122 abuts against the outer plate 32 and is biased towards the outer plate 32. In a disengaged configuration, the pad 122 is substantially spaced apart from the outer plate 32.

The movement between the engaged and disengaged configurations may be achieved in any suitable manner, for example by attaching the pad 122 to a threaded rod 124 which threadedly engages a threaded bore (not seen in the drawings) formed into the trolley 35. The threaded rod 124 is rotated within the threaded bore using a handle 126 located at an end 128 thereof located substantially opposed to the pad 122. The pad includes any material that may frictionally engage the outer plate 32, such as for example rubber.

In use, the kit is assembled in either one of the above-described bridge crane 10 or jib crane 10′, 10″. Then, if an intended crane user wishes to transport the crane to another location or to assemble the other one of the bridge crane 10 or jib crane 10′, 10″, the assembled bridge crane 10 or jib crane 10′, 10″ is disassembled and the other one of the bridge crane 10 or jib crane 10′, 10″ is assembled.

Although the present invention has been described hereinabove by way of preferred embodiments thereof, it can be modified, without departing from the spirit and nature of the subject invention as defined in the appended claims.

What is claimed is:

1. A kit for use in alternatively assembling a bridge crane and a jib crane, said kit being usable with a lifting equipment, said kit comprising:
a support beam for supporting the lifting equipment;
first and second substantially elongated laterally stabilizing-spacing members;
first and second substantially elongated beam supporting-leg members, said first beam supporting-leg member defining substantially longitudinally opposed first beam supporting-leg member first and second ends, said second beam supporting-leg member defining substantially longitudinally opposed second beam supporting-leg member first and second ends;
a jib support member;
wherein in said bridge crane
said first and second laterally stabilizing-spacing members are located in a substantially coplanar and spaced apart relationship relatively to each other, said first and second laterally stabilizing-spacing members defining a bridge crane reference plane in which said first and second laterally stabilizing-spacing members both extend;
said first and second beam supporting-leg members are respectively attached to said first and second laterally stabilizing-spacing members so as to extend substantially away from said bridge crane reference plane; and
said support beam is attached to both said first and second beam supporting-leg members at a location respectively spaced apart from said first and second beam supporting-leg members first ends;
in said jib crane
said first and second beam supporting-leg members are located in a substantially coplanar and spaced apart relationship relatively to each other, said first and second laterally stabilizing-spacing members defining a jib crane reference plane in which said first and second laterally stabilizing-spacing members both extend;
said first and second laterally stabilizing-spacing members are each attached to both said first and second beam supporting-leg members;
said jib support member is attached to at least one of said first and second laterally stabilizing-spacing members and extends substantially away from said jib crane reference plane; and
said support beam is attached to said jib support member so as to be substantially spaced apart from said first and second beam supporting-leg members;
said support beam being usable in both said bridge crane and in said jib crane to support the lifting equipment, wherein
in said bridge crane, said support beam is supported at two spaced apart support locations, the lifting equipment being mountable to said support beam between said two spaced apart support locations; and
in said jib crane, said support beam is supported in a cantilevered configuration, the lifting equipment being mountable to said support beam spaced apart from said jib support member.

2. A kit as defined in claim 1, wherein said support beam is substantially elongated, said support beam defining two substantially longitudinally spaced apart attachment locations, said support beam being attachable to said jib support member alternatively at both of said attachment locations.

3. A kit as defined in claim 1, wherein in said jib crane, said support beam is alternatively attachable to said jib support member in an internally extending configuration and in an externally extending configuration, wherein in said internally extending configuration said support beam and said first and second beam supporting-leg members extend substantially in the same direction and in said externally extending configuration, said support beam extends in a direction opposite to a direction in which said first and second beam supporting-leg members extend.

4. A kit as defined in claim 1, wherein in said jib crane, said jib support member is alternatively attachable to each of said first and second laterally stabilizing-spacing members.

5. A kit as defined in claim 1, wherein said support beam is pivotally attached to said jib support member in said jib crane so as to be pivotable about a pivot axis, said pivot axis being substantially parallel to said jib crane reference plane.

6. A kit as defined in claim 5, further comprising a beam pivoting component, said beam pivoting component being operatively coupled to said support beam for selectively pivoting said support beam about said pivot axis so as to move an extremity of said beam substantially away from said jib crane reference plane.

7. A kit as defined in claim 6, wherein said beam pivoting component is substantially elongated, said beam pivoting component being attached to both said support beam and said jib support member at locations substantially distal relatively to locations at which said support beam and said jib support member are attached to each other, said beam pivoting component being selectively operable between a shortest lifting component configuration and a longest lifting component configuration, wherein in said shortest lifting component configuration said beam pivoting component is shorter than in said longest lifting component configuration, whereby changing a length of said beam pivoting component pivots said beam pivoting component relatively to said jib support member.

8. A kit as defined in claim 1, wherein at least one of said first and second beam supporting-leg members is selectively configurable between a leg shortest configuration and leg longest configuration, wherein in said leg shortest configuration, the length of said at least one of said first and second beam supporting-leg members is smaller than the length of said at least one of said first and second beam supporting-leg members in said leg longest configuration.

9. A kit as defined in claim 8, wherein said at least one of said first and second beam supporting-leg members includes a first leg tube and a second leg tube slidably mounted within said first leg tube, wherein alternating between said leg shortest and longest configurations is achieved, at least in part, by sliding said second leg tube relatively to said first leg tube.

10. A kit as defined in claim 9, further comprising a lock for locking said first and second leg tubes relatively to each other so as to prevent said first and second leg tubes from sliding relatively to each other.

11. A kit as defined in claim 1, wherein said first and second beam supporting-leg members and said first and second laterally stabilizing-spacing members each take the form of a tube having a substantially square cross-section.

12. A kit as defined in claim 1, further comprising at least one reinforcing member, said reinforcing member being attachable to at least two distinct members from the set consisting of said first and second beam supporting-leg members, said first and second laterally stabilizing-spacing members and said jib support member so as to triangulate said at least two distinct members.

13. A kit as defined in claim 1, wherein said beam has a substantially I-shaped cross-section and defines
first and second outer plates, said first and second outer plates being in a substantially parallel and spaced apart relationship relatively to each other; and
an intermediate plate extending from both said first and second outer plates so as to connect said first and second outer plates to each other.

14. A kit as defined in claim 13, further comprising
two beam blocks attached to said support beam between said first and second outer plates in said jib crane;
two block-to-jib support linking members, said block-to-jib support linking members being each attached to a respective one of said beam blocks and to said jib support member in said jib crane, thereby attaching said support beam to said jib support member.

15. A kit as defined in claim 1, wherein in said jib crane, said at least one of said first and second laterally stabilizing-spacing members includes a pair of substantially outwardly extending flanges, said substantially outwardly extending flanges being substantially spaced apart from each other, said jib support member being positioned between and attached to both of said substantially outwardly extending flanges.

16. In combination, a kit as defined in claim 1 and a lifting equipment, said lifting equipment being mountable to said support beam.

17. A combination as defined in claim 16, wherein said lifting equipment includes a trolley substantially longitudinally movable relatively to said support beam.

18. A combination as defined in claim 17, wherein said trolley includes a brake for selectively blocking and allowing a substantially longitudinal movement of said trolley relatively to said support beam.

19. A kit for use in alternatively assembling a bridge crane and a jib crane, said kit being usable with a lifting equipment, said kit comprising:
a support beam for supporting the lifting equipment;
first and second substantially elongated laterally stabilizing-spacing members;
first and second substantially elongated beam supporting-leg members, said first beam supporting-leg member defining substantially longitudinally opposed first beam supporting-leg member first and second ends, said second beam supporting-leg member defining substantially longitudinally opposed second beam supporting-leg member first and second ends;
a jib support member;
wherein in said bridge crane
said first and second laterally stabilizing-spacing members are located in a substantially coplanar and spaced apart relationship relatively to each other, said first and second laterally stabilizing-spacing members defining a bridge crane reference plane in which said first and second laterally stabilizing-spacing members both extend;
one of said first and second beam supporting-leg members is attached to one of said first and second laterally stabilizing-spacing members so as to extend substantially away from said reference plane
another one of said first and second beam supporting-leg members is attached to either another one of said first and second laterally stabilizing-spacing members or to said jib support member so as to extend substantially away from said bridge crane reference plane; and
said support beam is attached to both said first and second beam supporting-leg members at a location respectively spaced apart from said first and second beam supporting-leg members first ends;
in said jib crane
said first and second beam supporting-leg members are located in a substantially coplanar and spaced apart relationship relatively to each other, said first and second laterally stabilizing-spacing members defining a jib crane reference plane in which said first and second laterally stabilizing-spacing members both extend;
said first and second laterally stabilizing-spacing members are each attached to both said first and second beam supporting-leg members;
said jib support member is attached to at least one of said first and second laterally stabilizing-spacing members and extends substantially away from said jib crane reference plane; and
said support beam is attached to said jib support member so as to be substantially spaced apart from said first and second beam supporting-leg members
said support beam being usable in both said bridge crane and in said jib crane to support the lifting equipment, wherein
in said bridge crane, said support beam is supported at two spaced apart support locations, the lifting equipment being mountable to said support beam between said two spaced apart support locations; and
in said jib crane, said support beam is supported in a cantilevered configuration, the lifting equipment being mountable to said support beam spaced apart from said jib support member.
